(19) United States
(12) Patent Application Publication
(10) Pub. No.: US 2016/0129834 A1
(43) Pub. Date: May 12, 2016

(54) SYSTEM AND METHOD FOR RECOGNIZING SURROUNDING VEHICLE

(71) Applicants: HYUNDAI MOBIS CO., LTD., Seoul (KR); Industry-University Cooperation Foundation Hanyang University, Seoul (KR)

(72) Inventors: Jeong Hee LEE, Uiwang-si (KR); Kun Soo HUH, Seoul (KR)

(73) Assignees: HYUNDAI MOBIS CO., LTD., Seoul (KR); Industry-University Cooperation Foundation Hanyang University, Seoul (KR)

(21) Appl. No.: 14/601,751

(22) Filed: Jan. 21, 2015

(30) Foreign Application Priority Data
Nov. 12, 2014 (KR) 10-2014-0156952

(51) Int. Cl. B60Q 9/00; G08G 1/052; G08G 1/056

(52) U.S. Cl. CPC B60Q 9/008; G08G 1/056; G08G 1/052

(57) ABSTRACT

Provided are a system and method for recognizing a surrounding vehicle. The system for recognizing a surrounding vehicle includes a vehicle information collecting unit configured to collect location information of an own vehicle and location information of a surrounding vehicle, a surrounding vehicle recognizing unit configured to generate a lane based on the location information of the own vehicle and the location information of the surrounding vehicle collected by the vehicle information collecting unit and to recognize a location of the surrounding vehicle based on the generated lane, and a situation notifying unit configured to determine a road situation based on the surrounding vehicle recognized by the surrounding vehicle recognizing unit.

### CROSS-REFERENCE TO RELATED APPLICATIONS

This application claims priority under 35 U.S.C. §119 to Korean Patent Application No. 10-2014-0156952, filed on Nov. 12, 2014, the disclosure of which is incorporated herein by reference in its entirety.

### TECHNICAL FIELD

The present invention relates to a system and method for recognizing a surrounding vehicle, and more particularly, to a system and method for effectively recognizing a surrounding vehicle via wireless access for vehicle environment (WAVE).

### BACKGROUND

Recently, a method for recognizing a surrounding vehicle and a method for recognizing a lane to be applied to applications for reducing accident risks have actively been researched in the automobile industry.

In general, lanes and surrounding vehicles are detected based on images captured through cameras or sensors provided in vehicles.

However, camera or sensor-based lane detection may not be properly performed depending on weather or ambient brightness. For example, lanes on the road may easily be detected in a fine day, but when its dark or weather is bad due to snow, rain, or the like, lanes may not be detected through a camera or a sensor or, if ever, a lane of a narrow field may merely be detected.

Also, when sunlight is strong, lanes may not be easily detected through an image captured by a camera or a sensor due to backlight, or the like.

Thus, radar or vision sensors are largely used in vehicles, but due to the foregoing limitations of the sensors, research into a method for recognizing a surrounding vehicle via wireless access for vehicle environment (WAVE) technique has actively been conducted.

### SUMMARY

Accordingly, the present invention provides a system and method for effectively recognizing a surrounding vehicle using wireless access for vehicle environment (WAVE).

In one general aspect, a system for recognizing a surrounding vehicle includes: a vehicle information collecting unit configured to collect location information of an own vehicle and location information of a surrounding vehicle; a surrounding vehicle recognizing unit configured to generate a lane based on the location information of the own vehicle and the location information of the surrounding vehicle collected by the vehicle information collecting unit and to recognize a location of the surrounding vehicle based on the generated lane; and a situation notifying unit configured to determine a road situation based on the surrounding vehicle recognized by the surrounding vehicle recognizing unit.

The vehicle information collecting unit may collect present location information and past location information of the own vehicle and present location information and past location information of the surrounding vehicle.

The vehicle information collecting unit may include: a vehicle movement information receiving unit configured to collect movement information of the own vehicle; a vehicle location information receiving unit configured to collect location information of the own vehicle; a surrounding vehicle information receiving unit configured to receive location information of the surrounding vehicle from the surrounding vehicle; and an own vehicle information collecting unit configured to generate present and past location information of own vehicle based on the movement information of the own vehicle and the location information of the own vehicle.

The vehicle movement information receiving unit may receive the movement information of the own vehicle via an internal vehicle network (IVN).

The surrounding vehicle information receiving unit may receive the location information of the surrounding vehicle via wireless access for vehicle environment (WAVE).

The surrounding vehicle recognizing unit may determine whether a preceding vehicle exists, and when it is determined that a preceding vehicle does not exist, the surrounding vehicle recognizing unit may combine location information of a rear surrounding vehicle and the location information of the own vehicle to generate a rear lane.

When it is determined that preceding vehicles exist, the surrounding vehicle recognizing unit may combine pieces of location information of the preceding surrounding vehicles to generate a front lane, combine the location information of the rear surrounding vehicle and the location information of the own vehicle to generate a rear lane, and subsequently combine the front lane and the rear lane to generate a final lane.

In another general aspect, a method for recognizing a surrounding vehicle includes: collecting present and past location information of an own vehicle; collecting present and past location information of a surrounding vehicle; generating a lane based on the present and past location information of the own vehicle and the present and past location information of the surrounding vehicle; and recognizing a location of the surrounding vehicle based on the generated lane.

The collecting of present and past location information of the own vehicle may include collecting movement information and location information of the own vehicle and generating present and past location information of the own vehicle based on the movement information and location information of the own vehicle.

The movement information of the own vehicle may be received via internal vehicle network (IVN).

The present and past location information of the surrounding vehicle may be received from the surrounding vehicle via wireless access for vehicle environment (WAVE).

The generating of a lane may include: collecting present and past location information of the own vehicle and present and past location information of the surrounding vehicle; determining whether a preceding vehicle exists; and generating a rear lane or a final lane including a front lane and a rear lane depending on whether a preceding vehicle exists.

The determining of whether preceding vehicles exist comprises: when it is determined that preceding vehicles do not exist, combining location information of the rear surrounding vehicle and location information of the own vehicle to generate the rear lane.

The determining of whether preceding vehicles exist may include: when it is determined that preceding vehicles exist, combining pieces of location information of the preceding surrounding vehicles to generate a front lane; combining the location information of the rear surrounding vehicle and the location information of the own vehicle to generate a rear lane; and combining the front lane and the rear lane to generate a final lane.

The method may further include: after the recognizing of the location of the surrounding vehicle based on the generated lane, determining a road situation based on the recognized location of the surrounding vehicle and notifying about the determination result.

Other features and aspects will be apparent from the following detailed description, the drawings, and the claims.

### BRIEF DESCRIPTION OF THE DRAWINGS

FIG. 1 is a block diagram of a system for recognizing a surrounding vehicle according to an embodiment of the present invention.

FIG. 2 is a detailed block diagram of a vehicle information collecting unit illustrated in FIG. 1.

FIGS. 3A to 3C are views illustrating a process of generating a lane and recognizing a surrounding vehicle by a surrounding vehicle recognizing unit illustrated in FIG. 1.

FIG. 4 is a view illustrating a three-dimensional (3D) curve obtained by the surrounding vehicle recognizing unit illustrated in FIG. 1.

FIG. 5 is a flow chart illustrating an operation of a method for recognizing a surrounding vehicle according to an embodiment of the present invention.

FIG. 6 is a flow chart illustrating a process of generating a lane illustrated in FIG. 5.

FIG. 7A to 7C is a view illustrating examples of lanes generated according to the lane generating process illustrated in FIG. 6.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the specification, like numbers refer to like elements.

In describing embodiments of the present invention, a detailed description of known techniques associated with the present invention unnecessarily obscure the gist of the present invention, it is determined that the detailed description thereof will be omitted. Moreover, the terms used henceforth have been defined in consideration of the functions of the present invention, and may be altered according to the intent of a user or operator, or conventional practice. Therefore, the terms should be defined on the basis of the entire content of this specification.

Hereinafter, a system and method for recognizing a surrounding vehicle according to embodiments of the present invention will be described in detail with reference to the accompanying drawings.

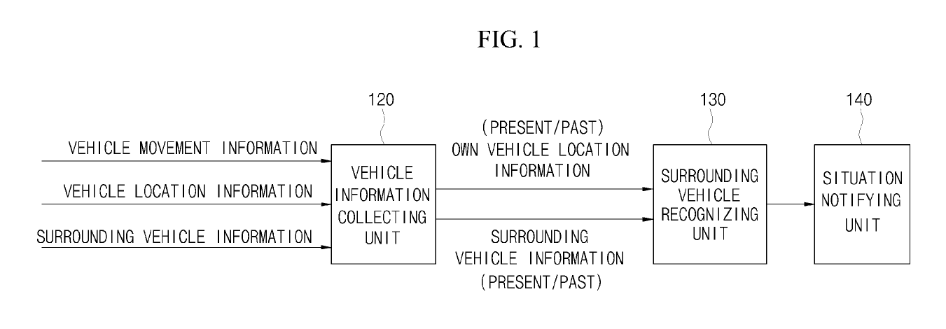

FIG. 1 is a block diagram of a system for recognizing a surrounding vehicle according to an embodiment of the present invention.

Referring to FIG. 1, a system 110 for recognizing a surrounding vehicle according to an embodiment of the present invention, which is implemented to a lane by using present and past own vehicle location information and present and past surrounding vehicle location information and recognizing a location of a surrounding vehicle based on the generated lane, includes a vehicle information collecting unit 120, a surrounding vehicle recognizing unit 130, and a situation notifying unit 140.

The vehicle information collecting unit 120, serving to collect own vehicle location information and surrounding vehicle location information, collects present and past location information of an own vehicle and collects present and past location information of a surrounding vehicle.

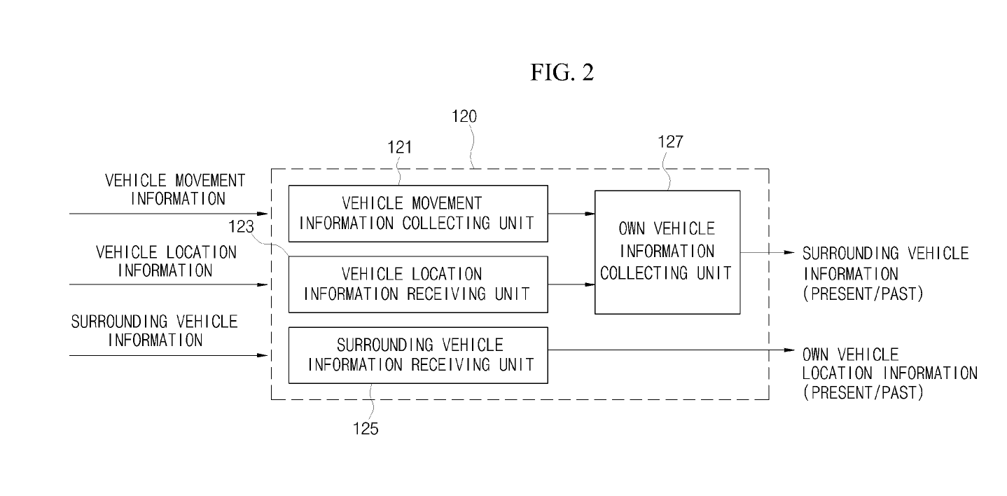

The vehicle information collecting unit 120 may be configured to collect own vehicle location information through an internal vehicle network (IVN) and a global positioning system (GPS) and collect present and past location information of a surrounding vehicle from the surrounding vehicle through a wireless access for vehicle environment (WAVE). A detailed configuration and operation of the vehicle information collecting unit 120 will be described with reference to FIG. 2 hereinafter.

The surrounding vehicle recognizing unit 130 recognizes a location of the surrounding vehicle based on the present and past location information of the own vehicle and the present and past location information of the surrounding vehicle collected by the vehicle information collecting unit 120.

Here, the surrounding vehicle recognizing unit 130 may generate a lane based on the present location information and past location information of the surrounding vehicle, and recognizes a location of the surrounding vehicle with respect to the own vehicle based on the generated lane. A specific method of generating a lane and recognizing a vehicle by the surrounding vehicle recognizing unit 130 will be described hereinafter.

The situation notifying unit 140 determines a road situation based on the location of the surrounding vehicle recognized by the surrounding vehicle recognizing unit 130 and informs about the determined road situation. In particular, the situation notifying unit 140 determines likelihood of occurrence of an accident, and when it is determined that there is likelihood of occurrence of an accident, the situation notifying unit 140 notifies about the determination result.

FIG. 2 is a detailed block diagram of the vehicle information collecting unit 120 illustrated in FIG. 1.

Referring to FIG. 2, the vehicle information collecting unit 120, serving to collect location information of an own vehicle and location information of a surrounding vehicle, collects present and past location information of the own vehicle and present and past location information of the surrounding vehicle.

The vehicle information collecting unit 120 includes a vehicle movement information receiving unit 121, a vehicle location information receiving unit 123, a surrounding vehicle information receiving unit 125, and an own vehicle information collecting unit 127.

The vehicle movement information receiving unit 121 receives various types of movement information of a vehicle such as vehicle body movement information, handle operation information, and the like, by using the internal vehicle network (VIN).

The vehicle location information receiving unit 123, for example, a global positioning system (GPS) receiving module, receives location information of a vehicle.

Vehicle information collected by the vehicle movement information receiving unit 121 and the vehicle location information receiving unit 123 are used to generate past location information and present location information of a vehicle. Here, the past location information of a vehicle refers to path history information.

The surrounding vehicle information receiving unit 125 collects present and past location information of the surrounding vehicle from the surrounding vehicle via wireless access for vehicle environment (WAVE).

The own vehicle information collecting unit 127 generates past location information and present location information of the vehicle based on the vehicle information collected by the vehicle movement information receiving unit 121 and the vehicle location information receiving unit 123.

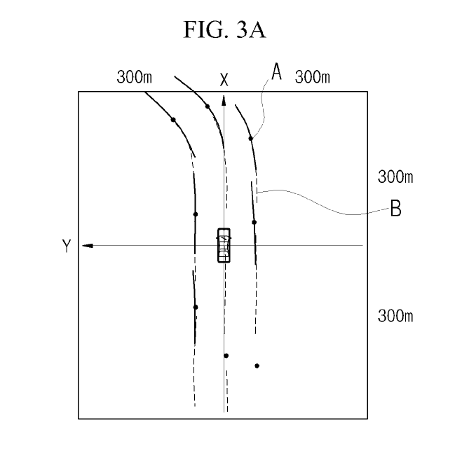

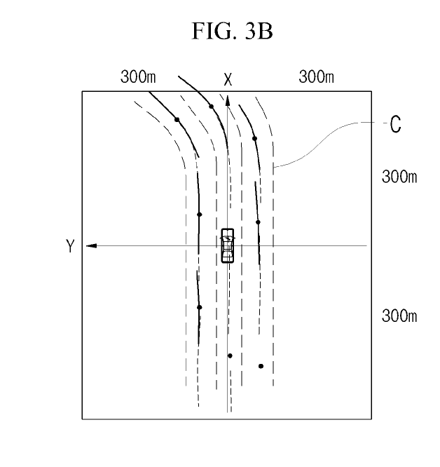

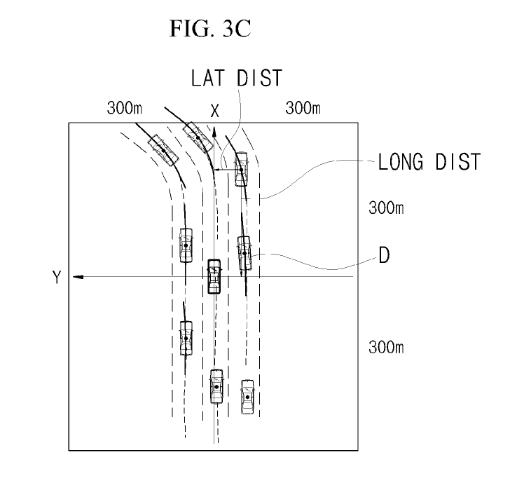

FIGS. 3A to 3C are views illustrating a process of generating a lane and recognizing a surrounding vehicle by the surrounding vehicle recognizing unit 130 illustrated in FIG. 1.

First, as illustrated in FIG. 3A, the surrounding vehicle recognizing unit 130 obtains present location information A of the surrounding vehicle and past location information B of the surrounding vehicle.

Next, as illustrated in FIG. 3B, the surrounding vehicle recognizing unit 130 generates a lane C based on the obtained present location information A and the past location information B of the surrounding vehicle.

After generating the lane C, as illustrated in FIG. 3C, the surrounding vehicle recognizing unit 130 recognizes a location D of the surrounding vehicle on the generated land C.

The surrounding vehicle recognizing unit 130 according to an embodiment of the present invention uses a method of interpolating the present location information of the vehicle and the past location information of the vehicle to a 3D curve.

In order to interpolate a 3D curve, a minimum of four positions (points) are required, and here, the past location information (path history) of the vehicle is composed of a total of 23 points and a 3D curve may be sufficiently interpolated by using the current location point and the prediction points of the vehicle through path prediction.

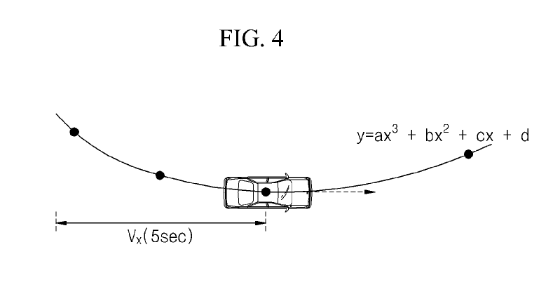

FIG. 4 is a view illustrating a three-dimensional (3D) curve obtained by the surrounding vehicle recognizing unit 130 according to an embodiment of the present invention.

In FIG. 4, point E denotes past location information of the vehicle, F denotes the present location of the vehicle, and point G denotes a location calculated through path prediction. When the total of four points are obtained as illustrated in FIG. 4, a, b, c, and d, parameter values, of a cubic function as expressed as the following Equation (1) may be calculated.

y=ax³+bx²+cx+d (1)

The present invention relates to a method for generating a lane through communication information of a vehicle, and thus, to this end, a lane is expressed in the form of a cubic function and Equation (1) is a basic formula used to generate a lane in the present invention.

So far, the configuration and function of the system for recognizing a surrounding vehicle according to an embodiment of the present invention has been described with reference to FIGS. 1 through 4. Hereinafter, a method for recognizing a surrounding vehicle according to the configuration of the system for recognizing a surrounding vehicle according to an embodiment of the present invention will be described in stages.

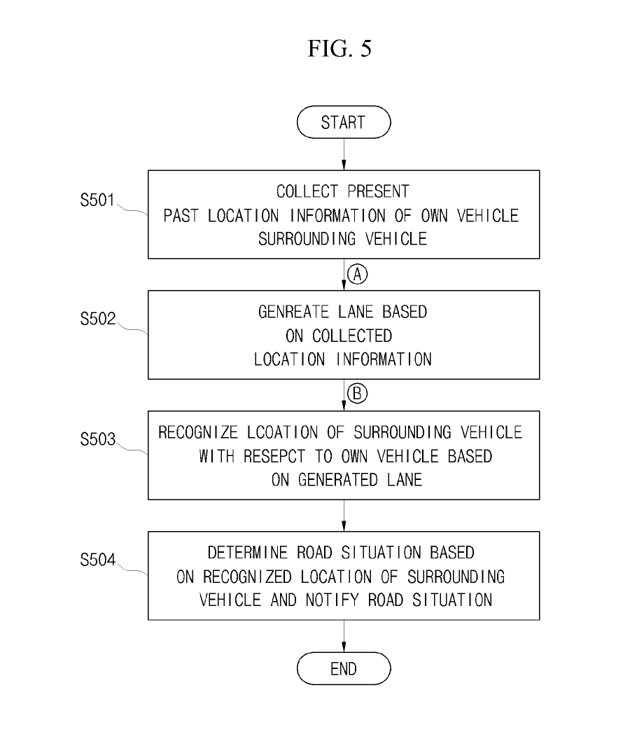

FIG. 5 is a flow chart illustrating an operation of a method for recognizing a surrounding vehicle according to an embodiment of the present invention.

First, the vehicle information collecting unit 120 collects present and past location information of an own vehicle and present and past location information of a surrounding vehicle in step S510.

Here, the vehicle information collecting unit 120 collects movement information and location information of the own vehicle, generates present and past location information of the own vehicle based on the movement information and location information of the own vehicle, and collects present and past in formation of the surrounding vehicle via wireless access for vehicle environment (WAVE).

When the present and past location information of the own vehicle and the present and past location information of the surrounding vehicle are collected, the surrounding vehicle recognizing unit 130 generates a lane in step S520 and recognizes a location of the surrounding vehicle with respect to the own vehicle based on the generated lane in step S530.

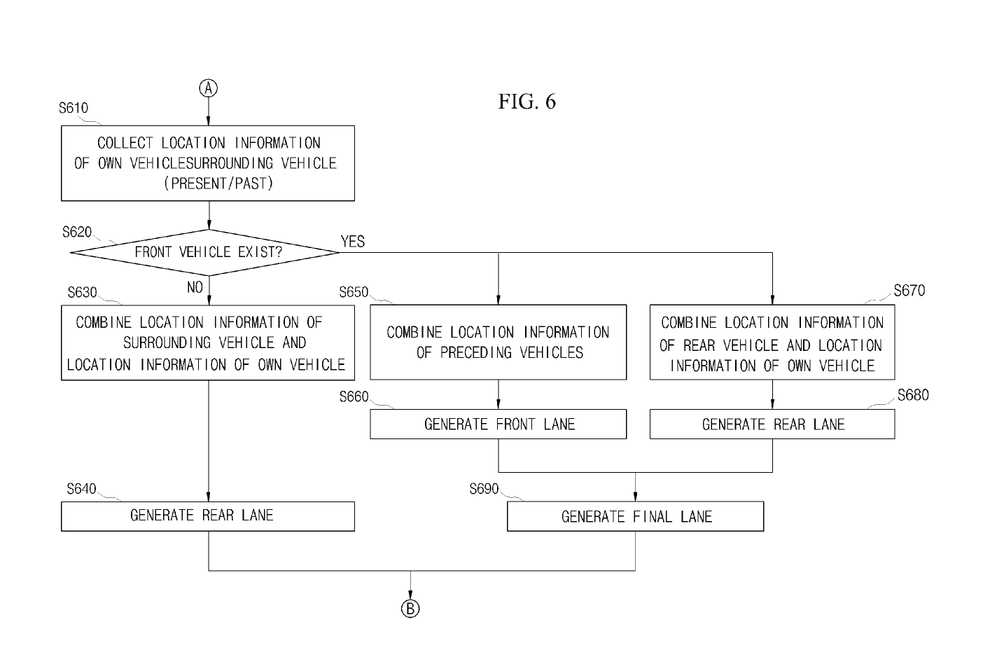

The method of generating a land by the surrounding vehicle recognizing unit 130 will be described with reference to FIG. 6 hereinafter.

When the location of the surrounding vehicle is recognized in step S530, the situation notifying unit 140 determines a road situation based on the recognized location of the surrounding vehicle and notifies about the determined road situation in step S540. In particular, the situation notifying unit 140 determines likelihood of occurrence of an accident, and when it is determined that there is likelihood of occurrence of an accident, the situation notifying unit 140 notifies about the determination result.

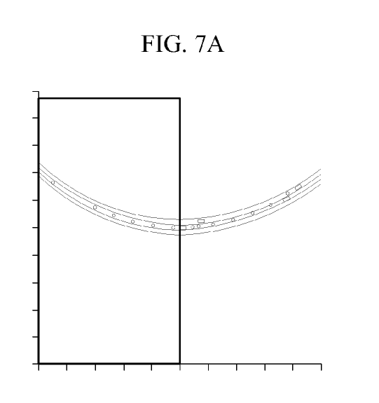

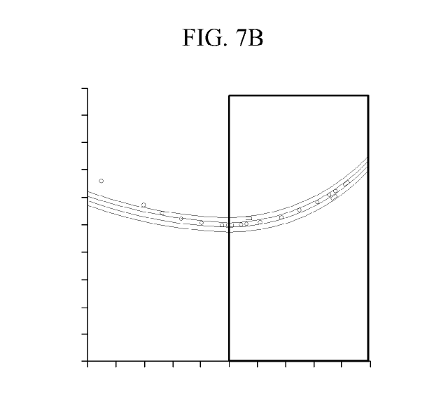

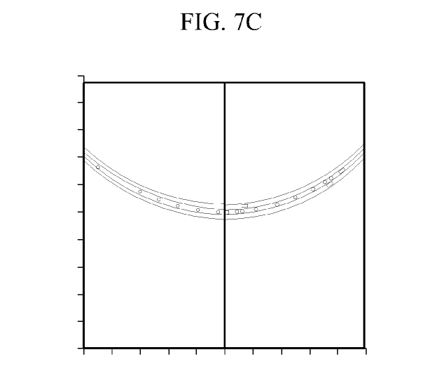

FIG. 6 is a flow chart illustrating the step of generating a lane (S520) illustrated in FIG. 5, and FIGS. 7A to 7C are views illustrating examples of lanes generated according to the step of generating a lane according to an embodiment of the present invention.

Referring to FIGS. 6 and 7A to 7C, location information of the own vehicle and location information of the surrounding vehicle are received in step S610, and here, present and past location information of the own vehicle and present and past location information of the surrounding vehicle are received.

When the location information are received in step S610, it is determined whether there is a preceding vehicle in step S620, and when it is determined that there is no preceding vehicle (S620: No), location information of a rear surrounding vehicle and the location information of the own vehicle are combined in step S630 to generate a rear lane as illustrated in FIG. 7A in step S640.

When it is determined that there is a preceding vehicle in step S620 (S620: Yes), pieces of location information of front surrounding vehicles are combined in step S650 to generate a front lane as illustrated in FIG. 7B in step S660, and combine location information of rear surrounding vehicle and the location information of the own vehicle in step S670 to generate a rear lane as illustrated in FIG. 7A in step S680.

Thereafter, the front lane generated in step S660 and the rear lane generated in step S680 are combined to generate a final lane as illustrated in FIG. 7 C in step S690.

According to embodiments of the present invention, since a surrounding vehicle is recognized by using wireless access for vehicle environment (WAVE), a limitation of an existing driver assistance system (DAS) sensor can be complemented.

In addition, since software may be installed in a vehicle equipped with a vehicle-to-everything (V2X) terminal, hardware is not additionally required.

The system and method for recognizing a surrounding vehicle has been described according to the embodiments, but the scope of the present invention is not limited to a specific embodiment. The present invention may be corrected and modified within the technical scope obvious to those skilled in the art.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for recognizing a surrounding vehicle, the system comprising:
a vehicle information collecting unit configured to collect location information of an own vehicle and location information of a surrounding vehicle;
a surrounding vehicle recognizing unit configured to generate a lane based on the location information of the own vehicle and the location information of the surrounding vehicle collected by the vehicle information collecting unit and to recognize a location of the surrounding vehicle based on the generated lane; and
a situation notifying unit configured to determine a road situation based on the surrounding vehicle recognized by the surrounding vehicle recognizing unit.

2. The system of claim 1, wherein the vehicle information collecting unit collects present location information and past location information of the own vehicle and present location information and past location information of the surrounding vehicle.

3. The system of claim 1, wherein the vehicle information collecting unit comprises:
a vehicle movement information receiving unit configured to collect movement information of the own vehicle;
a vehicle location information receiving unit configured to collect location information of the own vehicle;
a surrounding vehicle information receiving unit configured to receive present and past location information of the surrounding vehicle from the surrounding vehicle; and
an own vehicle information collecting unit configured to generate present and past location information of the own vehicle based on the movement information of the own vehicle and the location information of the own vehicle.

4. The system of claim 3, wherein the vehicle movement information receiving unit receives the movement information of the own vehicle via an internal vehicle network (IVN).

5. The system of claim 3, wherein the surrounding vehicle information receiving unit receives the location information of the surrounding vehicle via wireless access for vehicle environment (WAVE).

6. The system of claim 1, wherein the surrounding vehicle recognizing unit determines whether a preceding vehicle exists, and when it is determined that a preceding vehicle does not exist, the surrounding vehicle recognizing unit combines location information of a rear surrounding vehicle and the location information of the own vehicle to generate a rear lane.

7. The system of claim 6, wherein when it is determined that preceding vehicles exist, the surrounding vehicle recognizing unit combines pieces of location information of the preceding surrounding vehicles to generate a front lane, combines the location information of the rear surrounding vehicle and the location information of the own vehicle to generate a rear lane, and subsequently combines the front lane and the rear lane to generate a final lane.

8. A method for recognizing a surrounding vehicle, the method comprising:
collecting present and past location information of an own vehicle;
collecting present and past location information of a surrounding vehicle;
generating a lane based on the present and past location information of the own vehicle and the present and past location information of the surrounding vehicle; and
recognizing a location of the surrounding vehicle based on the generated lane.

9. The method of claim 8, wherein the collecting of present and past location information of the own vehicle comprises: collecting movement information and location information of the own vehicle and generating present and past location information of the own vehicle based on the movement information and location information of the own vehicle.

10. The method of claim 9, wherein the movement information of the own vehicle is received via internal vehicle network (IVN).

11. The method of claim 8, wherein the present and past location information of the surrounding vehicle are received from the surrounding vehicle via wireless access for vehicle environment (WAVE).

12. The method of claim 8, wherein the generating of a lane comprises:
collecting present and past location information of the own vehicle and present and past location information of the surrounding vehicle;
determining whether a preceding vehicle exists; and
generating a rear lane or a final lane including a front lane and a rear lane depending on whether a preceding vehicle exists.

13. The method of claim 12, wherein the determining of whether preceding vehicles exist comprises: when it is determined that preceding vehicles do not exist, combining location information of the rear surrounding vehicle and location information of the own vehicle to generate the rear lane.

14. The method of claim 12, wherein the determining of whether preceding vehicles exist comprises:
when it is determined that preceding vehicles exist,
combining pieces of location information of the preceding surrounding vehicles to generate a front lane;
combining the location information of the rear surrounding vehicle and the location information of the own vehicle to generate a rear lane; and
combining the front lane and the rear lane to generate a final lane.

15. The method of claim 8, further comprising: after the recognizing of the location of the surrounding vehicle based on the generated lane, determining a road situation based on the recognized location of the surrounding vehicle and notifying about the determination result.
